(19) United States
(12) Patent Application Publication
(10) Pub. No.: US 2025/0016727 A1
(43) Pub. Date: Jan. 9, 2025

(54) COMMUNICATION METHOD, PROGRAM, AND INFORMATION PROCESSING TERMINAL

(71) Applicant: Panasonic Intellectual Property Management Co., Ltd., Osaka (JP)

(72) Inventor: Makoto OCHI, Osaka (JP)

(21) Appl. No.: 18/894,738

(22) Filed: Sep. 24, 2024

Related U.S. Application Data
(63) Continuation of application No. PCT/JP2023/012438, filed on Mar. 28, 2023.

(30) Foreign Application Priority Data
May 9, 2022 (JP) 2022-077112

(51) Int. Cl. H04W 64/00; H04W 60/04

(52) U.S. Cl. CPC H04W 64/00; H04W 60/04

(57) ABSTRACT

A communication method according to the present disclosure is a communication method for a communication system including an electronic device and an information processing terminal. The communication method includes: determining, by the information processing terminal, whether the information processing terminal is in short-range wireless communication with the electronic device; detecting, by the information processing terminal, position information indicative of a position of the information processing terminal; in response to determine that the information processing terminal is in short-range wireless communication with the electronic device, determining, by the information processing terminal, a place where the information processing terminal lies based on the detected position information and registered position information containing a registered position registered in advance and a registered place associated with the registered position; and outputting, by the information processing terminal, place determination information indicative of the determined place of the information processing terminal.

### CROSS REFERENCE TO RELATED APPLICATION

This is a continuation application of International Application No. PCT/JP2023/012438, with an international filing date of Mar. 28, 2023, which claims priority of Japanese Patent Application No. 2022-077112 filed on May 9, 2022, the content of which is incorporated herein by reference.

### BACKGROUND

### Technical Field

The present disclosure relates to a communication method, a program, and an information processing terminal.

### Background Art

JP2017167701A discloses a work support system capable of supporting and managing works of employees.

The work support system described in JP2017167701A includes a management server that manages works of employees, a mobile terminal carried by the employee and capable of accessing the management server via a communication network, and a database that manages data in cooperation with the management server. The mobile terminal transmits current position information and its acquisition time information to the management server on a periodic or irregular basis. The management server registers the position information and its acquisition time information of the mobile terminal in the database and compares the position information and the acquisition time information with the employee's work schedule data to determine whether the employee is going to carry out a specified work at a specified place at a specified time. Based on the result of the determination, the management server reads out work support data necessary for the employee to carry out the specified business from the database and provides it to the mobile terminal.

The work support system described in JP2017167701A still has room for improvement in terms of enhancing privacy protection.

### SUMMARY

The present disclosure provides a communication method, a program, and an information processing terminal, capable of enhancing privacy protection.

A communication method according to an aspect of the present disclosure is a communication method for a communication system including an electronic device and an information processing terminal, the communication method including:
determining, by the information processing terminal, whether the information processing terminal is in short-range wireless communication with the electronic device;
detecting, by the information processing terminal, position information indicative of a position of the information processing terminal;
in response to determine that the information processing terminal is in short-range wireless communication with the electronic device, determining, by the information processing terminal, a place where the information processing terminal lies based on the detected position information and registered position information containing a registered position registered in advance and a registered place associated with the registered position; and
outputting, by the information processing terminal, place determination information indicative of the determined place of the information processing terminal.

An information processing terminal according to another aspect of the present disclosure is an information processing terminal carrying out short-range wireless communication with an electronic device, including:
a processor;
a storage storing registered position information containing a registered position registered in advance and a registered place associated with the registered position;
a short-range wireless communicator communicating with the electronic device by short-range wireless communication;
a position information detector detecting position information indicative of a position of the information processing terminal; and
a network communicator outputting information via a network,
the processor determines whether the short-range wireless communicator communicates with the electronic device by short-range wireless communication,
in response to determine that the short-range wireless communicator communicates with the electronic device by short-range wireless communication, the processor determines a place where the information processing terminal lies based on the position information detected by the position information detector and the registered position information stored in the storage, and
the processor outputs, via the network communicator, place determination information indicative of the determined place of the information processing terminal.

A computer-readable storage medium according to another aspect of the present disclosure is a computer-readable storage medium having instructions stored thereon, which when executed by an information processing terminal, the instructions including:
determining whether the information processing terminal is in short-range wireless communication with an electronic device;
detecting position information indicative of a position of the information processing terminal;
in response to determine that the information processing terminal is in short-range wireless communication with the electronic device, determining a place where the information processing terminal lies based on the detected position information and registered position information containing a registered position registered in advance and a registered place associated with the registered position; and
outputting place determination information indicative of the determined place of the information processing terminal.

According to the present disclosure, there can be provided a communication method, a program, and an information processing terminal, capable of enhancing privacy protection.

### BRIEF DESCRIPTION OF DRAWINGS

FIG. 1 is a schematic block diagram showing a configuration of a communication system according to a first embodiment of the present disclosure;

FIG. 2 shows an example of registered position information;

FIG. 3 is a control flowchart of an information processing terminal according to the first embodiment of the present disclosure;

FIG. 4 is a control flowchart of a server according to the first embodiment of the present disclosure;

FIG. 5 is a control flowchart of a server of a first variant;

FIG. 6 is a control flowchart of an information processing terminal according to a second embodiment of the present disclosure;

FIG. 7 is a control flowchart of a server according to the second embodiment of the present disclosure;

FIG. 8 is a schematic block diagram showing a configuration of a communication system according to a third embodiment of the present disclosure; and

FIG. 9 is a control flowchart of an information processing terminal according to the third embodiment of the present disclosure.

### DETAILED DESCRIPTION

### Background to this Disclosure

In recent years, with the spread of remote work, an increasing number of users are working using electronic devices at places other than their workplaces, for example, such as their homes.

In recent years, systems have been developed that acquire position information of users and support and manage users who work at places other than their workplaces. For example, an information processing terminal such as a smartphone owned by a user detects position information and transmits the detected position information to a server. The server receives the position information from the mobile terminal and manages the user's position based on the position information.

In such a system, however, a third party can always know the specific position of the user based on the position information of the information processing terminal received by the server, which is undesirable from the viewpoint of protecting the user privacy.

Thus, the present inventors have studied a communication method capable of enhancing privacy protection and have come to the following disclosure.

Hereinafter, embodiments of the present disclosure will be described with reference to the accompanying drawings. Note that the following description is merely illustrative in nature and is not intended to limit the present disclosure, its applications, or its uses. Furthermore, the drawings are schematic, and the proportion, etc. of dimensions do not necessarily correspond to the real ones.

As used herein, terms such as “first” and “second” are used for illustrative purposes only and should not be construed as explicitly expressing or implying the relative importance or ranking of technical features. Features limited as the “first” and “second” expressly or impliedly include one or more of the features.

### First Embodiment

### (Overall Configuration)

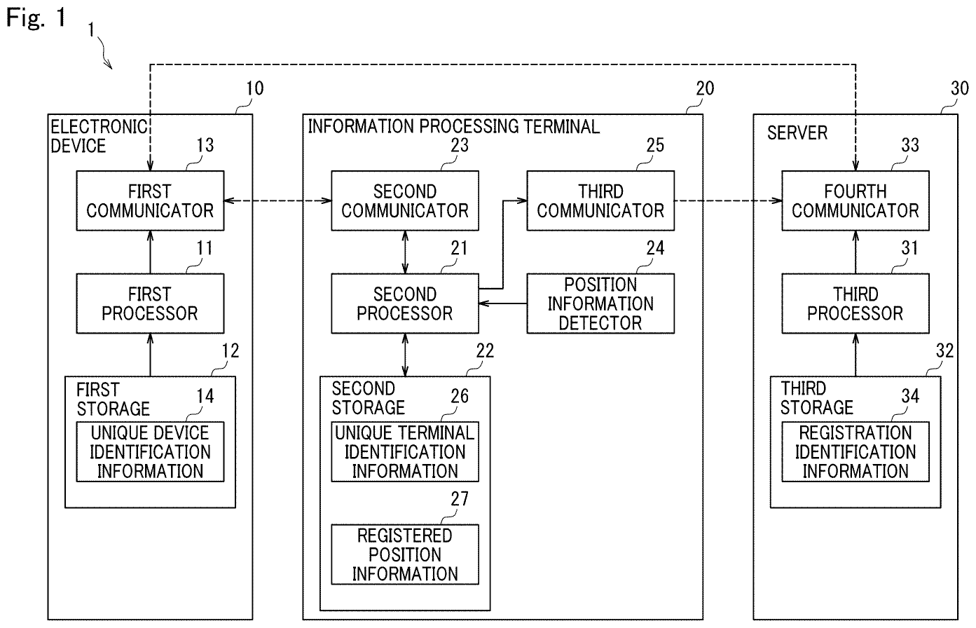

FIG. 1 is a schematic block diagram showing a configuration of a communication system 1 according to a first embodiment of the present disclosure. As shown in FIG. 1, the communication system 1 includes an electronic device 10, an information processing terminal 20, and a server 30. In the communication system 1, the electronic device 10 and the information processing terminal 20 carry out short-range wireless communication with each other. The electronic device 10 and the server 30 communicate with each other via a network, while the information processing terminal 20 and the server 30 communicate with each other via the network.

### <Electronic Device>

The electronic device 10 is, for example, a laptop PC. The electronic device 10 includes a first processor 11 and a first storage 12 that stores a program executed by the first processor 11. The electronic device 10 includes a first communicator 13 that carries out short-range wireless communication with the information processing terminal 20. The short-range wireless communication means, for example, wireless communication within meters. For example, the short-range wireless communication may be wireless communication within 50 m, preferably within 10 m, and more preferably within 5 m.

The first processor 11 controls each component of the electronic device 10. The first processor 11 can be implemented by a semiconductor element or the like. The first processor 11 can be configured by a microcomputer, a CPU, an MPU, a GPU, a DSP, an FPGA, or an ASIC. The first processor 11 reads out data and programs stored in the first storage 12 to carry out various arithmetic processes, to thereby implement predetermined functions.

The first storage 12 is a storage medium that stores programs and data necessary to implement the functions of the electronic device 10. The first storage 12 can be implemented by, for example, a RAM, a ROM, a PROM, an EPROM, a flash memory, an HDD, an SSD, or a combination thereof.

The first storage 12 stores unique device identification information 14. The unique device identification information 14 is unique identification information for identifying the electronic device 10 and contains, for example, a serial number.

The first communicator 13 includes a circuit for carrying out short-range wireless communication with the information processing terminal 20 in accordance with a predetermined communication standard. The predetermined communication standard includes, for example, Bluetooth (registered trademark).

The electronic device 10 includes a communication circuit that communicates with the server 30 via a network. For example, the electronic device 10 includes a communication circuit that can communicate in compliance with a standard such as Wi-Fi (registered trademark).

### <Information Processing Terminal>

The information processing terminal 20 is a mobile terminal that can be carried by a user and that can perform short-range wireless communication and position information detection. The information processing terminal 20 is, for example, a smartphone. The information processing terminal 20 includes a second processor 21, a second storage 22, a second communicator 23, a position information detector 24, and a third communicator 25.

The second processor 21 controls each component of the information processing terminal 20. The second processor 21 can be implemented by a semiconductor element or the like. The second processor 21 can be configured by a microcomputer, a CPU, an MPU, a GPU, a DSP, an FPGA, or an ASIC. The second processor 21 reads out data and programs stored in the second storage 22 to carry out various arithmetic processes, to thereby implement predetermined functions.

The second storage 22 is a storage medium that stores programs and data necessary to implement the functions of the information processing terminal 20. The second storage 22 can be implemented by, for example, a RAM, a ROM, a PROM, an EPROM, a flash memory, an HDD, an SSD, or a combination thereof.

The second storage 22 stores unique terminal identification information 26 and registered position information 27. The unique terminal identification information 26 is unique identification information for identifying the information processing terminal 20 and contains, for example, a serial number or a telephone number. The registered position information 27 contains a registered position registered in advance and a registered place associated with the registered position.

As used herein, “position” means, for example, a coordinate point such as latitude and longitude, while “place” means a name representing a position and is named in relation to the position. A “place” may be, for example, an arbitrarily named name of home, workplace, or the like. A “place” may also be, for example, a name of land, facility, building, or the like. A “place” does not include information that can identify a specific position.

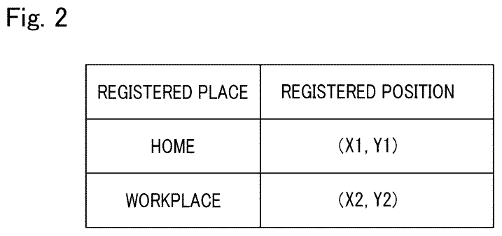

FIG. 2 shows an example of the registered position information 27. In the example shown in FIG. 2, the registered position indicates a latitude and a longitude. For example, it is shown that “home” as a registered place is associated with a registered position (X1, Y1) and that “workplace” as a registered place is associated with a registered position (X2, Y2). X1 and X2 indicate latitudes, while Y1 and Y2 indicate longitudes. A place other than the home and workplace and its position may be registered at the registered place information 27. For example, the name of a place such as a coworking space or a spot office and a position indicative of the place may be registered at the registered place information 27.

The second communicator 23 includes a circuit that carries out short-range wireless communication with the electronic device 10 in accordance with a predetermined communication standard. An example of the predetermined communication standard includes Bluetooth (registered trademark). In this specification, the second communicator 23 may be referred to as short-range wireless communicator 23.

The position information detector 24 detects position information of the information processing terminal 20. The position information detector 24 is, for example, a position detecting sensor such as a global positioning system (GPS).

The third communicator 25 includes a communication circuit carrying out wireless communication with the server 30 via a network. For example, the third communicator 25 may be any unit capable of communication in compliance with a standard such as Wi-Fi (registered trademark). In this embodiment, the third communicator 25 may be referred to as network communicator 25.

### <Server>

The server 30 is an information processing device capable of communicating with the electronic device 10 and the information processing terminal 20 via a network. The server 30 includes a third processor 31, a third storage 32, and a fourth communicator 33.

The third processor 31 controls each component of the server 30. The third processor 31 can be implemented by a semiconductor element or the like. The third processor 31 can be configured by a microcomputer, a CPU, an MPU, a GPU, a DSP, an FPGA, or an ASIC. The third processor 31 reads out data and programs stored in the third storage 32 to carry out various arithmetic processes, to thereby implement predetermined functions.

The third storage 32 is a storage medium that stores programs and data necessary to implement the functions of the server 30. The third storage 32 can be implemented by, for example, a RAM, a ROM, a PROM, an EPROM, a flash memory, an HDD, an SSD, or a combination thereof.

The third storage 32 stores registration identification information 34. The registration identification information 34 contains registered terminal identification information for identifying the information processing terminal 20 and registered device identification information for identifying the electronic device 10. The registered terminal identification information includes, for example, a serial number or a telephone number of the information processing terminal 20. The registered device identification information includes, for example, a serial number of the electronic device 10.

The fourth communicator 33 includes a communication circuit carrying out wireless communication with the information processing terminal 20 and the electronic device 10 via a network. For example, the fourth communicator 33 may be any circuit capable of communication in compliance with a standard such as Wi-Fi (registered trademark).

### (Operation)

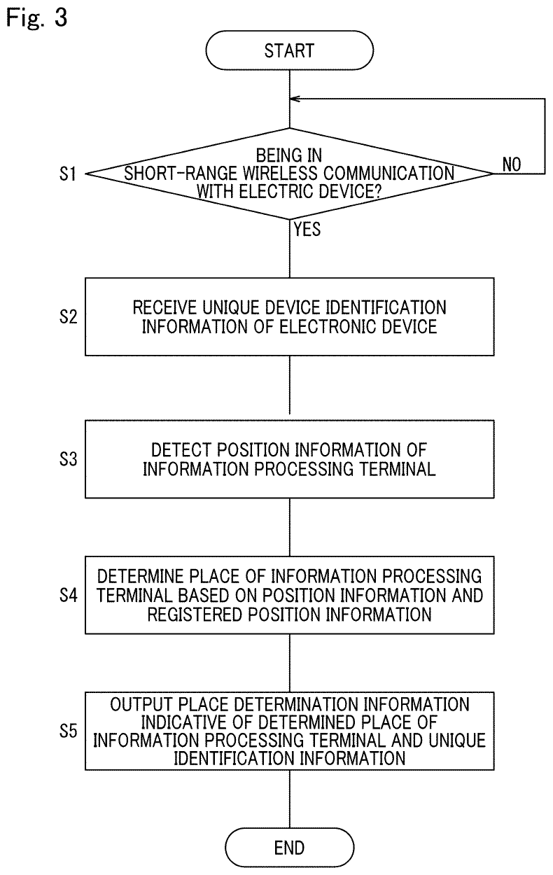

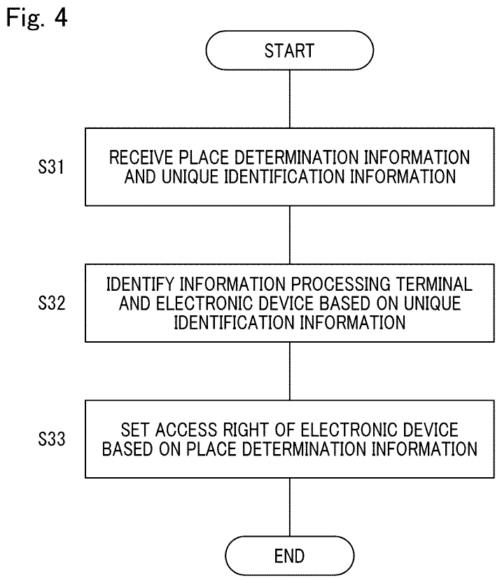

An example of an operation of the communication system 1, that is, an example of a communication method will be described with reference to FIGS. 3 and 4.

FIG. 3 shows a control flowchart of the information processing terminal 20 according to the first embodiment of the present disclosure.

As shown in FIG. 3, at step S1, the information processing terminal 20 determines whether it is carrying out short-range wireless communication with the electronic device 10. For example, the second processor 21 determines whether the second communicator 23 is carrying out short-range wireless communication with the electronic device 10. It is thus determined whether the information processing terminal 20 is near the electronic device 10.

If the second communicator 23 and the first communicator 13 of the electronic device 10 are carrying out short-range wireless communication with each other, the second processor 21 determines that the information processing terminal 20 is near the electronic device 10. If the second communicator 23 and the first communicator 13 of the electronic device 10 are not carrying out short-range wireless communication with each other, the second processor 21 determines that the information processing terminal 20 is not near the electronic device 10.

If it is determined at step S1 that the information processing terminal 20 is carrying out short-range wireless communication with the electronic device 10, the process proceeds to step S2. If it is determined that the information processing terminal 20 is not carrying out short-range wireless communication with the electronic device 10, the process repeats step S1.

At step S2, the information processing terminal 20 receives the unique device identification information 14 of the electronic device 10. For example, in the electronic device 10, the first processor 11 reads out the unique device identification information 14 stored in the first storage 12 and outputs the unique device identification information 14 via the first communicator 13. In the information processing terminal 20, the second processor 21 carries out short-range wireless communication with the first communicator 13 via the second communicator 23, to thereby receive the unique device identification information 14. The second processor 21 stores the received unique device identification information 14 into the second storage 22.

At step S3, the information processing terminal 20 detects position information. For example, the position information detector 24 detects information on latitude and longitude as the position information of the information processing terminal 20.

At step S4, the information processing terminal 20 determines a place of the information processing terminal 20 based on the detected position information and the registered position information 27. For example, the second processor 21 receives the position information of the information processing terminal 20 from the position information detector 24. The second processor 21 reads out the registered position information 27 stored in the second storage 22. The second processor 21 searches for the position information detected by the position information detector 24 from among registered places registered in advance at the registered place information 27, to determine the place of the information processing terminal 20. Specifically, the second processor 21 determines whether the information processing terminal 20 is at a registered place registered in advance, based on the detected position information and the registered position information 27.

For example, if the position information detected by the position information detector 24 is a position (X1, Y1), the second processor 21 searches for the position (X1, Y1) from among the registered positions at the registered place information 27. As shown in FIG. 2, at the registered place information 27, the position (X1, Y1) is associated with “home” as a registered place. The second processor 21 thus determines that the information processing terminal 20 is at “home”. In other words, the second processor 21 determines that the information processing terminal 20 is “at a registered place”.

If the position information detected by the position information detector 24 is a position (X0, Y0), the position (X0, Y0) is not registered at the registered place information 27. In this case, the second processor 21 determines that the information processing terminal 20 is neither at “home” nor at “workplace”. That is, the second processor 21 determines that the information processing terminal 20 is “not at either registered place”.

In determining a place of the information processing terminal 20, the second processor 21 may determine whether the detected position information is within a predetermined range from a registered position, i.e., latitude and longitude, previously registered of the registered position information 27. As an example, a case will be described where the detected position information is a position (X3, Y3). If the detected position (X3, Y3) is within a predetermined range (X1±α, Y1±β) from the registered position (X1, Y1) indicative of the place of the home at the registered place information 27, the second processor 21 may determine that the information processing terminal 20 is at “home”. Any numerical values may be set for “a” and “B”.

At step S5, the information processing terminal 20 outputs place determination information indicating the determined place of the information processing terminal 20 and unique identification information thereof. For example, the second processor 21 outputs the place determination information and the unique identification information of the information processing terminal 20 by the third communicator 25. In this embodiment, the second processor 21 transmits the place determination information and the unique identification information via the network to the server 30 by the third communicator 25.

The place determination information is information indicative of the place where the information processing terminal 20 lies. In this embodiment, the place determination information is information on the place of the information processing terminal 20 determined at step S3 and is information indicating, for example, that the information processing terminal 20 is “at home”, “at workplace”, or “not at either registered place”. For example, the place determination information may be information indicating that the information processing terminal 20 is “at a registered place” or “not at a registered place” without distinction between home and workplace.

The unique identification information includes the unique device identification information 14 received from the electronic device 10 and the unique terminal identification information 26 of the information processing terminal 20. The unique identification information is stored in the second storage 22. The second processor 21 reads out the unique identification information from the second storage 22 and transmits the unique identification information via the third communicator 25 to the server 30.

The information processing terminal 20 outputs the place determination information and the unique identification information periodically or irregularly. For example, the information processing terminal 20 may output the place determination information and the unique identification information when the power of the electronic device 10 is turned on. The information processing terminal 20 may output the place determination information and the unique identification information at a predetermined time. The information processing terminal 20 may output the place determination information and the unique identification information at a predetermined time interval. For example, the information processing terminal 20 may output the place determination information and the unique identification information every hour. Alternatively, the information processing terminal 20 may detect whether the user has moved based on the position information and output the place determination information and the unique identification information when detecting that the user has moved.

FIG. 4 shows a control flowchart of the server 30 according to the first embodiment of the present disclosure.

As shown in FIG. 4, at step S31, the server 30 receives the place determination information and the unique identification information from the information processing terminal 20. For example, the fourth communicator 33 receives the place determination information and the unique identification information via a network from the third communicator 25 of the information processing terminal 20.

At step S32, the server 30 identifies the information processing terminal 20 and the electronic device 10 based on the unique identification information. The server 30 stores the registration identification information 34 in the third storage 32. The registration identification information 34 includes the registered terminal identification information of the information processing terminal 20 registered in advance and the registered device identification information of the electronic device 10 registered in advance. The third processor 31 reads out the registration identification information 34 from the third storage 32 and searches for the unique identification information from the registration identification information 34. Specifically, the third processor 31 searches for the unique terminal identification information 26 of the information processing terminal 20 from the registered terminal identification information of the registration identification information 34. The third processor 31 searches for the unique device identification information 14 of the electronic device 10 from the registered device identification information of the registration identification information 34. The third processor 31 thus identifies the information processing terminal 20 and the electronic device 10 communicating via the network.

At step S33, the server 30 sets an access right of the electronic device 10 based on the place determination information. For example, if the information processing terminal 20 is “not at a registered place”, the third processor 31 limits the access of the electronic device 10 to the server 30. On the other hand, if the information processing terminal 20 is “at a registered place”, the third processor 31 permits the access of the electronic device 10 to the server 30.

Alternatively, the third processor 31 may change the level of the access right of the electronic device 10 to the server 30 depending on whether the information processing terminal 20 is “at home” or “at workplace”. For example, the third processor 31 may partially limit access of the electronic device 10 to the server 30 if the information processing terminal 20 is “at home”.

### Effects

According to the communication system 1 of the first embodiment, the following effects can be achieved.

In the communication system 1, the information processing terminal 20 determines a place where the information processing terminal 20 lies from the position information of the information processing terminal 20, to output place determination information indicative of the determined place. The place determination information is for example, information indicating that the information processing terminal 20 is “at a registered place” such as a home or workplace, or “not at a registered place”, and does not indicate a specific position. This avoids a situation where the specific position of the user possessing the information processing terminal 20 is always known to a third party such as, for example, an administrator. As a result, the protection of user privacy can be improved.

For example, if the user possessing the information processing terminal 20 is at “home”, the information processing terminal 20 outputs place determination information of “at home” and does not output position information specifically indicating the position of “home”. Alternatively, if the user is at a “cafe”, the information processing terminal 20 outputs place determination information of “not at a registered place” and does not output position information specifically indicating the position of the “cafe”. In this way, the information processing terminal 20 outputs the determination result of “whether the user is at a registered place” and does not output position information indicating a specific position. This improves the situation to avoid where the server 30 receiving the place determination information from the information processing terminal 20 can always grasp the specific position of the user. In consequence, so-called location harassment can be avoided that an administrator grasps the specific position of a user and violates the user privacy.

The server 30 sets an access right to the server 30 of the electronic device 10 that is in short-range communication with the information processing terminal 20, based on place determination information indicating whether the information processing terminal 20 is “at a registered place or not”. For example, if it is determined that the user is using the electronic device 10 at a place other than the registered place, the server 30 limits access of the electronic device 10 to the server 30. On the other hand, if the user is determined to be using the electronic device 10 at a registered place, the server 30 permits access of the electronic device 10 to the server 30. This configuration prevents the electronic device 10 from accessing the server 30 from a place other than the registered place, achieving improved security.

When the information processing terminal 20 is carrying out short-range wireless communication with the electronic device 10, the information processing terminal 20 determines a place of the information processing terminal 20 and outputs place determination information. In this manner, the communication system 1 controls the access of the electronic device 10 to the server 30 by combining the place determination information and the information on whether the electronic device 10 and the information processing terminal 20 are in short-range communication with each other. This further improve the security of the access of the electronic device 10 to the server 30.

The communication method can also achieve the same effects as those described above.

In this embodiment, the electronic device 10 is a laptop PC, but the electronic device 10 is not limited thereto. For example, the electronic device 10 may be a computer such as a desktop PC or a tablet PC.

In this embodiment, the example has been described where the information processing terminal 20 is a smartphone, but the present disclosure is not limited thereto. The information processing terminal 20 may be any mobile terminal having a short-range wireless communication function and a position information detection function. For example, the information processing terminal 20 may be a tablet PC.

In this embodiment, the example has been described where the information processing terminal 20 determines a place of the information processing terminal 20 based on the position information detected by the position information detector 24 and the registered position information 27, but the present disclosure is not limited thereto. For example, the information processing terminal 20 may transmit the position information detected by the position information detector 24 to the server 30. In this case, the server 30 may determine a place of the information processing terminal 20 based on the position information. That is, step S4 shown in FIG. 3 may be carried out by the server 30.

Although in this embodiment, the example has been described where the information processing terminal 20 transmits the unique identification information to the server 30, this is not limitative. For example, the information processing terminal 20 may not transmit the unique identification information to the server 30.

Although in this embodiment, the example has been described where the unique identification information includes the unique device identification information 14 and the unique terminal identification information 26, this is not limitative. The unique identification information may include at least the unique terminal identification information 26. For example, the unique identification information may not include the unique device identification information 14. In this case, step S2 shown in FIG. 3 may be omitted.

The registered terminal identification information and the registered device identification information may be linked in the registration identification information 34 stored in the third storage 32 of the server 30. In this case, the third processor 31 of the server 30 can identify the electronic device 10 based on the unique terminal identification information 26 of the information processing terminal 20 and the registration identification information 34, without using the unique device identification information 14.

Although in this embodiment, as shown in FIG. 2, the example has been described where one registered position is associated with one registered place, the present disclosure is not limited thereto. For example, a predetermined range may be associated with one registered place.

Although in this embodiment, the example of limiting access to the server 30 has been described, the present disclosure is not limited thereto. For example, the server 30 may limit the operation of the electronic device 10 based on the place determination information.

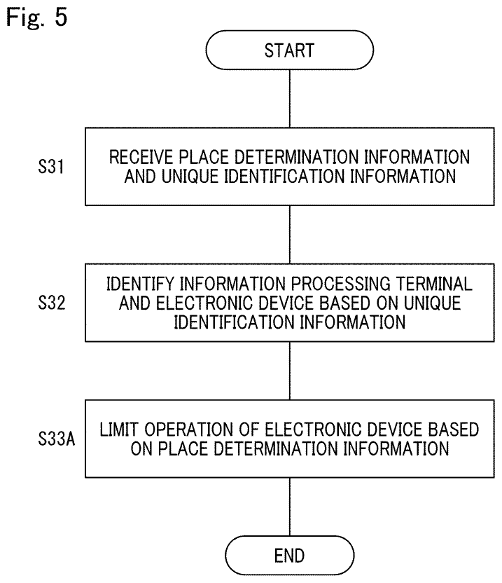

FIG. 5 is a control flowchart of the server 30 of a first variant. As shown in FIG. 5, the control of the first variant differs from that of the embodiment 1 in that it includes step S33A at which the server 30 limits the operation of the electronic device 10.

For example, at step S33A, the third processor 31 may limit login to the electronic device 10 if the information processing terminal 20 is “not at a registered place”. On the other hand, the third processor 31 may permit login to the electronic device 10 if the information processing terminal 20 is “at a registered place”.

Alternatively, at step S33A, the third processor 31 may limit the use of specific devices such as a camera, speaker, microphone, card slot, or input/output terminal if the information processing terminal 20 is “not at a registered place”. On the other hand, the third processor 31 may permit the use of specific devices such as a camera, speaker, microphone, card slot, or input/output terminal if the information processing terminal 20 is “at a registered place”.

### Second Embodiment

A communication method according to a second embodiment of the present disclosure will be described. In the second embodiment, differences from the first embodiment will mainly be described. In the second embodiment, the same or equivalent configurations as those in the first embodiment will be described with the same reference numerals. In the second embodiment, descriptions overlapping with those in the first embodiment will be omitted.

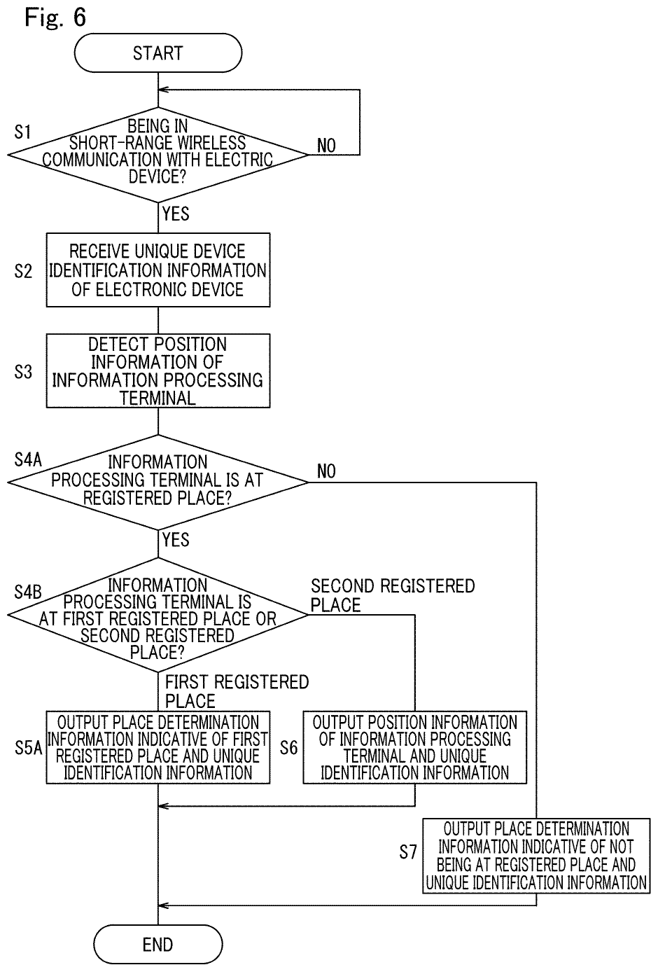

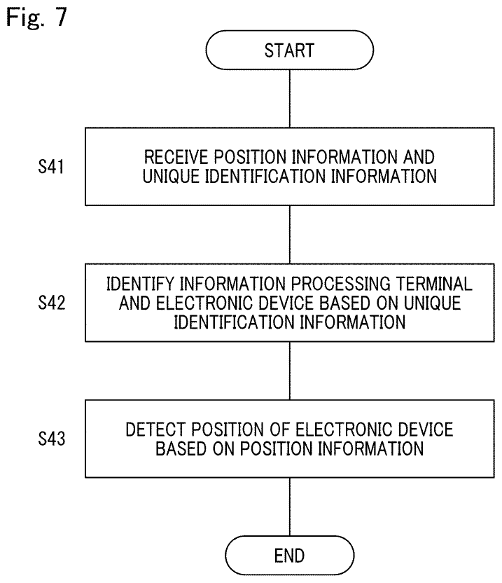

An example of a communication method of the second embodiment will be described with reference to FIG. 6 and FIG. 7. FIG. 6 is a control flowchart of the information processing terminal 20 according to the second embodiment of the present disclosure. FIG. 7 is a control flowchart of the server 30 according to the second embodiment of the present disclosure.

The second embodiment differs from the first embodiment in that it determines whether to output place determination information or position information of the information processing terminal 20 depending on the place where the information processing terminal 20 lies. Specifically, as shown in FIG. 6, the communication method of the second embodiment differs from that of the first embodiment in that it includes steps S4A, S4B, S5A, and S7.

At step S4A, it is determined whether the information processing terminal 20 is at a registered place. For example, the information processing terminal 20 determines whether the information processing terminal 20 is at a registered place based on the position information detected at step S3 and the registered position information 27.

If it is determined at step S4A that the information processing terminal 20 is at the registered place, the process proceeds to step S4B. If it is determined that the information processing terminal 20 is not at the registered place, the process proceeds to step S7.

At step S4B, it is determined whether the information processing terminal 20 is at a first registered place or a second registered place registered in advance. The first registered place and the second registered place are different. For example, the first registered place may be “home” and the second registered place may be “workplace”.

If it is determined at step S4B that the information processing terminal 20 is at the first registered place, the process proceeds to step SSA. If the information processing terminal 20 is determined to be at the second registered place, the process proceeds to step S6.

At step S5A, the information processing terminal 20 outputs place determination information indicative of the first registered place where the information processing terminal 20 lies and the unique identification information. For example, if the first registered place is “home”, the information processing terminal 20 outputs place determination information indicating that the information processing terminal 20 is “at home”. For example, the information processing terminal 20 outputs place determination information including place identification information by which it can be identified that the information processing terminal 20 is “at home”.

At step S6, the information processing terminal 20 outputs the position information and the unique identification information of the information processing terminal 20. For example, if the second registered place is the “workplace”, the information processing terminal 20 outputs the position information of the information processing terminal 20 detected at step S3.

At step S7, the information processing terminal 20 outputs place determination information indicating that the information processing terminal 20 is not at either registered place and unique identification information.

Control of the server 30 will then be described with reference to FIG. 7. Here, an example will be described where the server 30 receives the position information and the unique identification information output from the information processing terminal 20 at step S5. The control where the server 30 receives the place determination information and the unique identification information output from the information processing terminal 20 at steps S5A and S7 is the same as that of FIG. 4 in the first embodiment, and hence a description thereof will be omitted.

As shown in FIG. 7, at step S41, the server 30 receives the position information and the unique identification information output from the information processing terminal 20. For example, the fourth communicator 33 receives the position information and the unique identification information via a network from the third communicator 25 of the information processing terminal 20.

At step S42, the server 30 identifies the information processing terminal 20 and the electronic device 10 based on the unique identification information. Step S42 is similar to step S32 in the first embodiment, and hence a description thereof will be omitted.

At step S43, the server 30 detects the position of the electronic device 10 based on the position information. For example, the server 30 detects the specific position of the information processing terminal 20 based on the position information of the information processing terminal 20. Since the information processing terminal 20 and the electronic device 10 are in short-range wireless communication with each other, the electronic device 10 is near the information processing terminal 20. The server 30 can therefore detect the position of the electronic device 10 by detecting the position of the information processing terminal 20.

For example, if the second registered place, “workplace,” includes a plurality of work areas, the server 30 can detect at which of the plurality of work areas the electronic device 10 lies based on the position information of the information processing terminal 20.

### Effects

According to the communication method of the second embodiment, the following effects can be achieved.

In the communication method of the second embodiment, it is determined whether to output place determination information or position information of the information processing terminal 20 depending on the place where the information processing terminal 20 lies. Such a configuration allows the user to select whether to output place determination information or position information of the information processing terminal 20 depending on the environment where the user works using the electronic device 10, thereby improving the usability of the communication system 1.

For example, if a user is working using the electronic device 10 at a workplace, the information processing terminal 20 transmits position information indicative of a specific position to the server 30. The server 30 can detect where in the workplace the electronic device 10 and the information processing terminal 20 lie based on the position information. This enables asset management of the electronic device 10 and the information processing terminal 20 in the workplace when the user is at the workplace.

On the other hand, if the user is at a place other than the workplace, for example, at home, the information processing terminal 20 transmits place determination information not containing a specific position to the server 30. The server 30 can obtain information that the electronic device 10 and the information processing terminal 20 are “at home”, but cannot ascertain the specific positions. This prevents the server 30 from ascertaining the specific position of the user when the user is away from the workplace, thus inhibiting the invasion of the user privacy.

In this embodiment, the example has been described where the first registered place is “home” and the second registered place is “workplace,” but this is not limitative. For example, the second registered place may be a “spot office” or the like. The first registered place and the second registered place can be set arbitrarily. The number of registered places is not limited to two. For example, the number of registered places may be two or more.

In this embodiment, the example has been described where if the information processing terminal 20 is determined to be at the second registered place “workplace,” the information processing terminal 20 outputs position information, but the present disclosure is not limited thereto. The registered place for which position information is output may be set arbitrarily. The information processing terminal 20 may output position information for registered places other than “workplace”.

### Third Embodiment

A communication system according to a third embodiment of the present disclosure will be described. In the third embodiment, differences from the first embodiment will mainly be described. In the third embodiment, the same or equivalent configurations as those in the first embodiment will be described with the same reference numerals. In the third embodiment, descriptions overlapping with those in the first embodiment will be omitted.

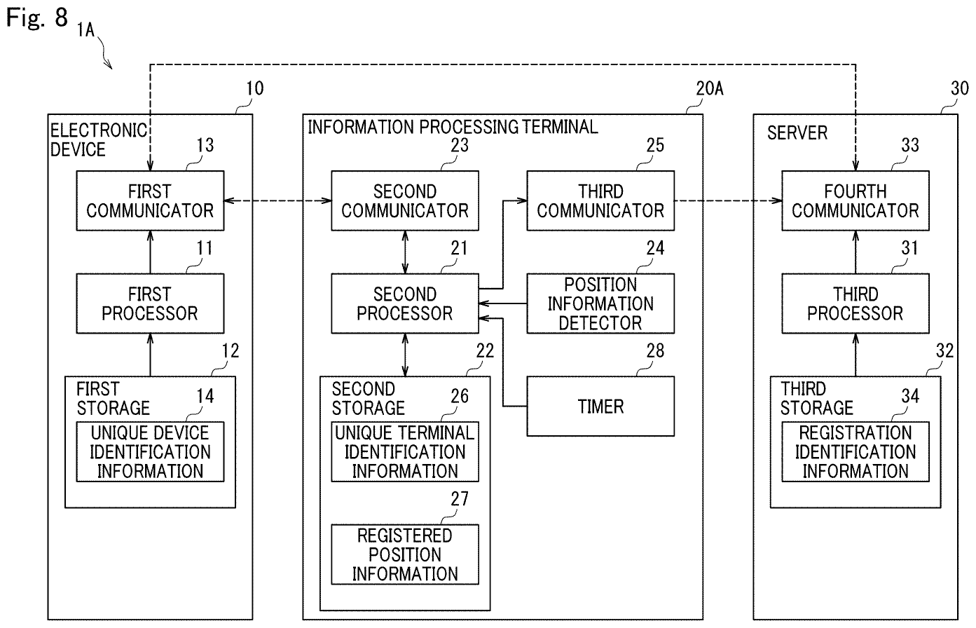

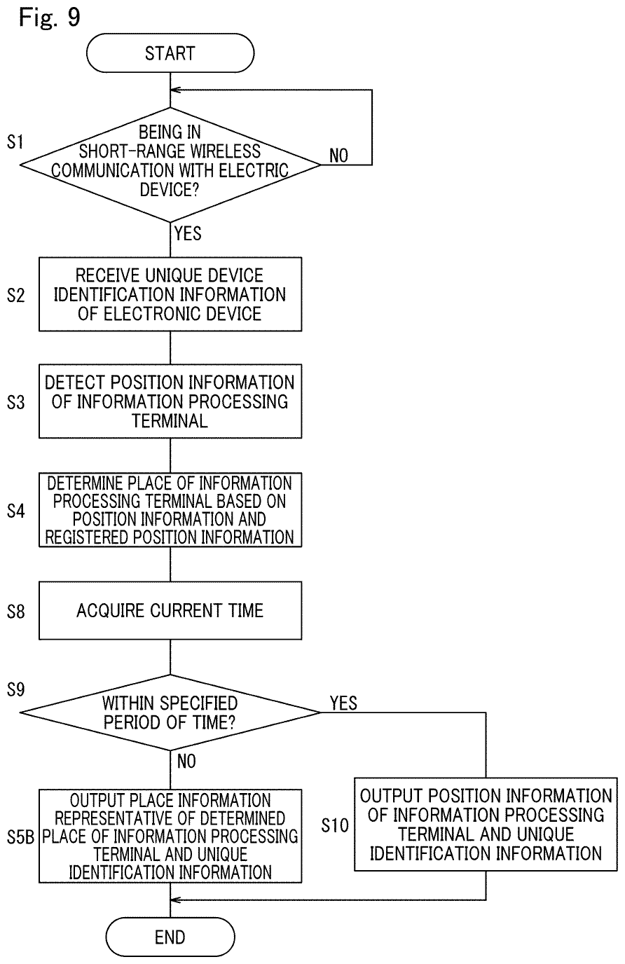

An example of a communication system 1A according to a third embodiment will be described with reference to FIG. 8. Control of an information processing terminal 20A according to the third embodiment will be described with reference to FIG. 9. FIG. 8 is a schematic block diagram showing a configuration of a communication system 1A according to the third embodiment of the present disclosure. FIG. 9 is a control flowchart of the information processing terminal 20A according to the third embodiment of the present disclosure.

The third embodiment differs from the first embodiment in that the information processing terminal 20A includes a timer 28 and determines whether to output place determination information or position information of the information processing terminal 20A based on whether it is within a predetermined period of time.

As shown in FIG. 8, in the communication system 1A, the information processing terminal 20A includes the timer 28. The timer 28 measures time. For example, the second processor 21 measures the current time using the timer 28. The second processor 21 thereby acquires information on the current time.

Control of the information processing terminal 20A will then be described with reference to FIG. 9. The third embodiment differs from the first embodiment in that it includes steps S8 to S10.

As shown in FIG. 9, at step S8, the information processing terminal 20A acquires the current time. For example, the second processor 21 acquires the current time by using the timer 28.

At step S9, the second processor 21 determines whether the current time acquired by the information processing terminal 20A is within a predetermined period of time. The predetermined time is an arbitrarily set time, for example, working hours. For example, if the working hours are from 9:00 a.m. to 12:00 a.m. and from 1:00 p.m. to 5:00 p.m., the second processor 21 determines whether the current time is within the range of from 9:00 a.m. to 12:00 a.m. and from 1:00 p.m. to 5:00 p.m.

At step S9, if it is determined that the current time is not within the predetermined time, the process proceeds to step S5B, whereas if it is determined that the current time is within the predetermined time, the process proceeds to step S10.

At step S5B, similarly to step S5 in the first embodiment, the information processing terminal 20A outputs the place determination information of the information processing terminal 20.

At step S10, similarly to step S6 in the second embodiment, the information processing terminal 20A outputs the position information of the information processing terminal 20A.

In the third embodiment, control of the server 30 is similar to that in the second embodiment, and hence a description thereof will be omitted.

### Effects

According to the communication method of the third embodiment, the following effects can be achieved.

In the communication method of the third embodiment, the information processing terminal 20A acquires the current time and determines whether to output place determination information or position information of the information processing terminal 20A based on the result of determination of whether the current time is within a predetermined period of time. For example, the information processing terminal 20A outputs position information during working hours and outputs place determination information outside working hours. This allows the server 30 to be set so that the positions of the electronic device 10 and the information processing terminal 20A can specifically be identified during working hours, but so that the positions of the electronic device 10 and the information processing terminal 20A cannot specifically be identified outside working hours. Such a configuration improves the usability of the communication system 1A.

Although in this embodiment, the example has been described where the information processing terminal 20A includes the timer 28, the present disclosure is not limited thereto. The timer 28 is not an essential component. For example, the information processing terminal 20A may acquire information on the current time from an external device.

Although in this embodiment, the example has been described where the predetermined time is working hours, the present disclosure is not limited thereto. The predetermined time may be set to any time. The predetermined time may be set differently for each information processing terminal 20A.

As above, the above embodiments have been described as exemplification of techniques in the present disclosure. However, the technique in the present disclosure is not limited to this, various changes, permutations, additions, omissions, etc. may be made within the scope of claims or their equivalents.

Since the above embodiments are for the purpose of exemplifying the techniques in the present disclosure, various changes, permutations, additions, omissions, etc. may be made within the scope of claims or their equivalents.

The above embodiments may be implemented by apparatuses, systems, methods, computer programs, computer-readable storage mediums, and combinations thereof.

### SUMMARY OF EMBODIMENTS

(1) A communication method according to the present disclosure is a communication method for a communication system including an electronic device and an information processing terminal. The communication method includes: determining, by the information processing terminal, whether the information processing terminal is in short-range wireless communication with the electronic device; detecting, by the information processing terminal, position information indicative of a position of the information processing terminal; in response to determine that the information processing terminal is in short-range wireless communication with the electronic device, determining, by the information processing terminal, a place where the information processing terminal lies based on the detected position information and registered position information containing a registered position registered in advance and a registered place associated with the registered position; and outputting, by the information processing terminal, place determination information indicative of the determined place of the information processing terminal.

(2) In the communication method according to (1), the determining a place of the information processing terminal may include determining whether the information processing terminal is at the registered place based on the position information and the registered position information. The outputting place determination information may include in response to determine that the information processing terminal is at the registered place, outputting place determination information indicative of the registered place where the information processing terminal lies.

(3) In the communication method according to (2), the outputting place determination information may include in response to determine that the information processing terminal is not at the registered place, outputting place determination information indicating that the information processing terminal is not at the registered place.

(4) In the communication method according to any one of (1) to (3), the determining a place of the information processing terminal may include determining whether the information processing terminal is at a first registered place or a second registered place different from the first registered place. The outputting place determination information may include in response to determine that the information processing terminal is at the first registered place, outputting place determination information indicative of the first registered place. The communication method may include: in response to determine that the information processing terminal is at the second registered place, outputting, by the information processing terminal, the position information of the information processing terminal.

(5) The communication method according to any one of (1) to (4) may include: acquiring a current time by the information processing terminal; and determining, by the information processing terminal, whether the acquired current time is within a predetermined period of time. The outputting place determination information may include in response to determine that the current time is not within the predetermined period of time, outputting the place determination information.

(6) The communication method according to (5) may include: in response to determine that the current time is within the predetermined period of time, outputting, by the information processing terminal, the position information of the information processing terminal.

(7) In the communication method according to any one of (1) to (6), the communication system may include a server connected via a network to the electronic device and the information processing terminal. The communication method may include: receiving, by the server, the place determination information output from the information processing terminal; and setting an access right of the electronic device to the server based on the place determination information.

(8) In the communication method according to any one of (1) to (6), the communication system may include a server connected via a network to the electronic device and the information processing terminal. The communication method may include: receiving, by the server, the place determination information output from the information processing terminal; and limiting an operation of the electronic device based on the place determination information.

(9) The communication method according to (7) or (8) may include: receiving, by the server, unique identification information including at least unique terminal identification information for identifying the information processing terminal; and identifying the information processing terminal and the electronic device based on the unique identification information and registration identification information including registered terminal identification information of the information processing terminal registered in advance and registered device identification information of the electronic device registered in advance.

(10) The communication method according to (9) may include: receiving, by the information processing terminal, unique device identification information for identifying the electronic device. The unique identification information may include the unique device identification information.

(11) In the communication method according to (4) or (6), the communication system may include a server connected via a network to the electronic device and the information processing terminal. The communication method may include: receiving, by the server, the position information output from the information processing terminal; and detecting a position of the electronic device based on the position information.

(12) A program according to the present disclosure is s a program executed by a communication system including an electronic device and an information processing terminal. The program includes: determining, by the information processing terminal, whether the information processing terminal is in short-range wireless communication with the electronic device; detecting, by the information processing terminal, position information indicative of a position of the information processing terminal; in response to determine that the information processing terminal is in short-range wireless communication with the electronic device, determining, by the information processing terminal, a place where the information processing terminal lies based on the detected position information and registered position information containing a registered position registered in advance and a registered place associated with the registered position; and outputting, by the information processing terminal, place determination information indicative of the determined place of the information processing terminal.

(13) An information processing terminal according to the present disclosure is an information processing terminal carrying out short-range wireless communication with an electronic device. The information processing terminal includes: a processor; a storage storing registered position information containing a registered position registered in advance and a registered place associated with the registered position; a short-range wireless communicator communicating with the electronic device by short-range wireless communication; a position information detector detecting position information indicative of a position of the information processing terminal; and a network communicator outputting information via a network. The processor determines whether the short-range wireless communicator communicates with the electronic device by short-range wireless communication. In response to determine that the short-range wireless communicator communicates with the electronic device by short-range wireless communication, the processor determines a place where the information processing terminal lies based on the position information detected by the position information detector and the registered position information stored in the storage. The processor outputs, via the network communicator, place determination information indicative of the determined place of the information processing terminal.

What is claimed is:

1. A communication method for a communication system including an electronic device and an information processing terminal, the communication method comprising:
determining, by the information processing terminal, whether the information processing terminal is in short-range wireless communication with the electronic device;
detecting, by the information processing terminal, position information indicative of a position of the information processing terminal;
in response to determine that the information processing terminal is in short-range wireless communication with the electronic device, determining, by the information processing terminal, a place where the information processing terminal lies based on the detected position information and registered position information containing a registered position registered in advance and a registered place associated with the registered position; and
outputting, by the information processing terminal, place determination information indicative of the determined place of the information processing terminal.

2. The communication method according to claim 1, wherein
the determining a place of the information processing terminal includes determining whether the information processing terminal is at the registered place based on the position information and the registered position information, and wherein
the outputting place determination information includes in response to determine that the information processing terminal is at the registered place, outputting place determination information indicative of the registered place where the information processing terminal lies.

3. The communication method according to claim 2, wherein
the outputting place determination information includes in response to determine that the information processing terminal is not at the registered place, outputting place determination information indicating that the information processing terminal is not at the registered place.

4. The communication method according to claim 1, wherein
the determining a place of the information processing terminal includes determining whether the information processing terminal is at a first registered place or a second registered place different from the first registered place, and wherein
the outputting place determination information includes in response to determine that the information processing terminal is at the first registered place, outputting place determination information indicative of the first registered place,
the communication method further comprising:
in response to determine that the information processing terminal is at the second registered place, outputting, by the information processing terminal, the position information of the information processing terminal.

5. The communication method according to claim 1, further comprising:
acquiring a current time by the information processing terminal; and
determining, by the information processing terminal, whether the acquired current time is within a predetermined period of time, wherein
the outputting place determination information includes in response to determine that the current time is not within the predetermined period of time, outputting the place determination information.

6. The communication method according to claim 5, further comprising:
in response to determine that the current time is within the predetermined period of time, outputting, by the information processing terminal, the position information of the information processing terminal.

7. The communication method according to claim 1, wherein
the communication system includes a server connected via a network to the electronic device and the information processing terminal,
the communication method further comprising:
receiving, by the server, the place determination information output from the information processing terminal; and
setting an access right of the electronic device to the server based on the place determination information.

8. The communication method according to claim 1, wherein
the communication system includes a server connected via a network to the electronic device and the information processing terminal,
the communication method further comprising:
receiving, by the server, the place determination information output from the information processing terminal; and
limiting an operation of the electronic device based on the place determination information.

9. The communication method according to claim 7, further comprising:
receiving, by the server, unique identification information including at least unique terminal identification information for identifying the information processing terminal; and
identifying the information processing terminal and the electronic device based on the unique identification information and registration identification information including registered terminal identification information of the information processing terminal registered in advance and registered device identification information of the electronic device registered in advance.

10. The communication method according to claim 9, further comprising:
receiving, by the information processing terminal, unique device identification information for identifying the electronic device, wherein
the unique identification information includes the unique device identification information.

11. The communication method according to claim 4, wherein
the communication system includes a server connected via a network to the electronic device and the information processing terminal,
the communication method further comprising:
receiving, by the server, the position information output from the information processing terminal; and
detecting a position of the electronic device based on the position information.

12. The communication method according to claim 8, further comprising:
receiving, by the server, unique identification information including at least unique terminal identification information for identifying the information processing terminal; and
identifying the information processing terminal and the electronic device based on the unique identification information and registration identification information including registered terminal identification information of the information processing terminal registered in advance and registered device identification information of the electronic device registered in advance.

13. The communication method according to claim 6, wherein
the communication system includes a server connected via a network to the electronic device and the information processing terminal,
the communication method further comprising:
receiving, by the server, the position information output from the information processing terminal; and
detecting a position of the electronic device based on the position information.

14. An information processing terminal carrying out short-range wireless communication with an electronic device, comprising:
a processor;
a storage storing registered position information containing a registered position registered in advance and a registered place associated with the registered position;
a short-range wireless communicator communicating with the electronic device by short-range wireless communication;
a position information detector detecting position information indicative of a position of the information processing terminal; and
a network communicator outputting information via a network, wherein
the processor determines whether the short-range wireless communicator communicates with the electronic device by short-range wireless communication, wherein
in response to determine that the short-range wireless communicator communicates with the electronic device by short-range wireless communication, the processor determines a place where the information processing terminal lies based on the position information detected by the position information detector and the registered position information stored in the storage, and wherein
the processor outputs, via the network communicator, place determination information indicative of the determined place of the information processing terminal.

15. The information processing terminal according to claim 14, wherein
the processor determines whether the information processing terminal is at the registered place based on the position information and the registered position information, and wherein
in response to determine that the information processing terminal is at the registered place, the processor outputs place determination information indicative of the registered place where the information processing terminal lies.

16. The information processing terminal according to claim 15, wherein
in response to determine that the information processing terminal is not at the registered place, the processor outputs place determination information indicating that the information processing terminal is not at the registered place.

17. The information processing terminal according to claim 14, wherein
the processor determines whether the information processing terminal is at a first registered place or a second registered place different from the first registered place, wherein
in response to determine that the information processing terminal is at the first registered place, the processor outputs place determination information indicative of the first registered place, and wherein
in response to determine that the information processing terminal is at the second registered place, the processor outputs the position information of the information processing terminal.

18. The information processing terminal according to claim 14, further comprising a timer acquiring a current time; wherein
the processor determines whether the acquired current time is within a predetermined period of time, and wherein
in response to determine that the current time is not within the predetermined period of time, the processor outputs the place determination information.

19. The information processing terminal according to claim 18, wherein
in response to determine that the current time is within the predetermined period of time, the processor outputs the position information of the information processing terminal.

20. A computer-readable storage medium having instructions stored thereon, which when executed by an information processing terminal, the instructions comprising:
determining whether the information processing terminal is in short-range wireless communication with an electronic device;
detecting position information indicative of a position of the information processing terminal;
in response to determine that the information processing terminal is in short-range wireless communication with the electronic device, determining a place where the information processing terminal lies based on the detected position information and registered position information containing a registered position registered in advance and a registered place associated with the registered position; and
outputting place determination information indicative of the determined place of the information processing terminal.
